(19) United States
(12) Patent Application Publication
(10) Pub. No.: US 2023/0225284 A1
(43) Pub. Date: Jul. 20, 2023

(54) A MONITORING SYSTEM

(71) Applicant: DEOSAN NEW ZEALAND LIMITED, Waharoa (NZ)

(72) Inventor: Christopher John BODLE, Cambridge (NZ)

(21) Appl. No.: 18/010,182

(22) PCT Filed: Jun. 16, 2021
(86) PCT No.: PCT/NZ2021/050098

§ 371 Date: Dec. 13, 2022

(30) Foreign Application Priority Data
Jun. 17, 2020 (NZ) 765490

(51) Int. Cl. A01J 5/007; A01J 7/02

(52) U.S. Cl. CPC A01J 5/007; A01J 7/022

(57) ABSTRACT

Disclosed is a monitoring system, and associated method, relating to the operation of a dairy plant, the system being adapted or able to monitor one or more of the following criteria: the mixing and/or dispensing of animal health products, the mixing and/or dispensing of teat treatments, the mixing and/or dispensing of chemicals, the mixing and/or dispensing of cleaning chemicals, the monitoring of plant cleaning operations, the usage of plant products/treatments/chemicals, and/or any other aspects associated with the operation of a dairy plant. The system is preferably able to monitor a dispensing system associated with a dairy plant.

### FIELD OF THE INVENTION

This invention relates to a monitoring system.

The monitoring system may be suitable for monitoring any criteria or conditions within a dairy shed/plant (referred to interchangeably and collectively herein as (dairy) ‘plant’ or (dairy) ‘shed’).

The monitoring system may be particularly suitable for monitoring operations within a dairy plant for dispensing teat treatments; and/or for monitoring operations within a dairy plant for using, dispensing and/or mixing cleaning chemicals; and/or for monitoring cleaning operations with a dairy plant, for example milk vat cleaning operations and overall dairy plant cleaning operations.

However, it is to be understood and appreciated that the invention may also have other applications and uses. The prior art and possible applications of the invention, as discussed below, are therefore given by way of example only.

### BACKGROUND

The production of quality dairy products relies on the supply of high-quality milk from dairy farms. To incentivise and control the quality of milk they receive, commercial dairy processors may audit the farms that supply them with raw milk, they may test and grade the milk received from the farms, and may offer a higher price for higher quality milk or penalise farms for supplying poor quality milk. Therefore, for farmers, maintaining good milk quality is important for farm productivity and profitability.

Milk quality is heavily influenced by animal health, particularly udder health. Mastitis is linked to lower milk output and lower quality milk. Each case of mastitis in a herd is also associated with a cost for medicaments, discarded milk, and labour. BMSCC (Bulk Milk SCC calculated from herd test data) is a measurement that reflects the estimated level of mastitis in a herd:
At 100,000 cells/ml, approximately 20% of cows have subclinical mastitis
At 200,000 cells/ml, approximately 30% of cows have subclinical mastitis
At 300,000 cells/ml, approximately 36% of cows have subclinical mastitis
At 400,000 cells/ml, approximately 40% of cows have subclinical mastitis.

It is desirable for the BMSCC to be kept as low as possible, and some dairy companies and/or processors have a maximum acceptable BMSCC.

Generally speaking, herds with BMSCC below 150,000 cells/ml have excellent mastitis control.

Tests are usually performed on milk samples at an independent testing laboratory using machines such as Fossomatics that count animal (somatic) cell nuclei stained with a fluorescent dye. To ensure machines are measuring cell counts accurately, laboratories in New Zealand use internationally recognized reference standards. BMSCC's are quoted as an actual test result for a particular sample, and can be summarised in forms such as arithmetic, geometric or rolling means.

From 1 Jan. 1998 the European Union required that milk from individual farms had to have BMSCC less than 400,000 cells/ml. Counts above this level are regarded as unfit for human consumption (European Union Directive 92/46/EC). Many dairy companies in the world have subsequently adopted this standard as a benchmark in their own quality schemes for competitive international trade in dairy products.

Current trends in dairy farming are towards increasing herd size. For example, in New Zealand, the average herd size tripled in the 30 seasons preceding 2019, and increased by more than 200 cows in 20 seasons. In large herds, preventing outbreaks of mastitis or other diseases is imperative to maintaining farm productivity and profitability.

Dairy farmers have a requirement to use cleaning chemicals in accordance with a wash programme outlined by regulation in New Zealand, being the NZCP1: Design and Operation of Farm Dairies. Animal health products registered for veterinary use such as teat spray are required to be used in accordance with label instructions showing directions for use or following veterinary advice. Milk producers typically have a contract with independent auditors who assess whether farmers are meeting these requirements in relation to cleaning procedures and in the use of animal health products registered as veterinary products. In many cases farmers record their information manually.

A number of products exist to treat mastitis, but the effectiveness of these products relies on correct mixing and dilution of the products and application to the dairy cow. Incorrect mixing/dilution and/or application of these products and/or the use of expired stock, and/or the use of old mixed product, and/or the use of poor-quality water, can lead to problems with residues or outbreaks of mastitis.

Another factor that can significantly influence milk quality is the cleanliness of the milking shed and/or dairy plant components. Bacterial residues resulting from fat and milk protein can build up in the piping and components of a dairy shed if it is not cleaned correctly at the end of each milking session. As this build up occurs, milk quality can be negatively affected. Milk quality that does not meet the minimum standards set by dairy processors can be rejected and/or financially penalised by the dairy processing company or plant, leading to loss of income to both dairy farmer and milk processor.

Effective cleaning of a shed and shed components relies heavily on the correct mixing and use of cleaning chemicals through the dairy plant. Incorrectly mixed or used cleaning chemicals may be ineffective in preventing fat and protein build up resulting in bacteria multiplying in the plant. Further, such cleaning chemical concentrates/formulations often require manual handling, including measuring and pouring the chemicals into vats and drums prior to use in the shed, exposing farm workers to the risk of chemical exposure—and so the risk of exposure to the chemicals as well as the risk of spillages is high.

All sheds will have a weekly wash programme schedule that they typically follow for both the shed wash and the bulk milk vat wash. This schedule will include hot and cold acid washes and hot alkali washes for the plant, and will include hot acid and hot alkali washes for the milk vats. In certain circumstances, where higher than normal residues have built up in the plant components and vat, a ‘bomb’ wash will be implemented. This is a process where the chemical concentrate of alkali and/or chlorine is mixed at twice the normal rate and circulated through the plant for maximum effect.

Where hot washes have been executed for both plant and milk vats it is important that the water leaving the plant be of a certain minimum temperature for the wash to be considered effective. At a temperature lower than 60° Celsius fat and/or protein deposits may be left in the plant. Measuring and knowing this temperature is therefore important to gauge the effectiveness of the wash.

Incorrect pH of an acid or alkali wash could lead to an ineffective wash. Knowing the pH of the water for an acid or alkali wash could determine whether the chemicals were dosed in their required amounts.

New dairy shed builds are now commonly installed with an automated wash system, some older sheds may have an automated wash system retrofitted, while other older sheds typically have some form of manual wash system operating in them. However, even automated wash systems do not guarantee correct use of shed cleaning chemicals or mitigate the health and safety risk inherent in handling the wash chemicals. In some instances, where a dairy shed has run out of a chemical, wash programmes can still be run without the required chemical while waiting for a new supply, resulting in ineffective cleaning.

Furthermore, automated wash systems in the more modern sheds will measure the amount of chemical concentrate they use for each wash, and this is generally measured by the run time of the dosing pump. It will also measure items such as water temperature before recirculation and before dumping. Error codes and timers are displayed on screen to keep the operator informed of the milking and washing process. This data is usually stored on the wash system computer and can only be accessed by viewing the screen for the system. It is not published or configured in a report format. If the shed independent hot water system malfunctions for whatever reason, and cold water is used for a hot wash, the automated wash system will record the water temperature, but it will not raise an alert or communicate to warn the farmer that the wash water temperature was too low. This information is displayed on the screen. This is clearly unsatisfactory.

A common issue in both manual and automated dairy sheds is farmers running out of chemicals which results in disrupting operations and posing a risk for milk quality.

Most dairy processors audit supplying farms to check there is good practice relating to shed cleaning and mastitis treatment amongst other things. Such audits typically involve a site visit, and checking manual cleaning practices and treatment logs. Manual logs rely on accurate, diligent, and honest recording by shed operators, and so they may often contain errors and/or inadvertently incorrect or missing information—they can also be easily fabricated to satisfy an auditor.

It would be advantageous therefore if there was an independent monitoring system that could be used for accurately and diligently monitoring (and/or recording) any criteria or conditions associated with any operation within, or associated with, a dairy shed/plant.

It may also be advantageous if the monitoring system was optionally able to alert a farmer/user to any potentially adverse issues, for example milk quality issues, plant/vat cleanliness issues and/or animal health issues.

Chemicals used in a dairy plant are an expensive consumable for dairy farm operations. Generally dairy farmers purchase these products per unit (by drum) which can vary in size from 20 kg to 20 lts-1000 ltr containers. Often the purchase of these chemicals is required prior to the end of the season, or the start of the season. This can coincide when farmer cash flow is low. A monitoring system that can identify volume used can allow for billing by quantity used as opposed to container/pack size which will provide farmers with flexibility and allow for better cash flow management with these products.

### Object

It is therefore an object of at least preferred embodiments of the present invention to go some way towards addressing one or more of the aforementioned problems or difficulties, or which at the very least provides the public with a useful choice.

### Definitions

Throughout this specification unless the text requires otherwise, the word ‘comprise’ and variations such as ‘comprising’ or ‘comprises’ will be understood to imply the inclusion of a stated integer or step or group of integers or steps but not the exclusion of any other integer or step or group of integers or steps.

It is intended that reference to a range of numbers disclosed herein (for example, 1 to 10) also incorporates reference to all rational numbers within that range and any range of rational numbers within that range (for example, 1 to 6, 1.5 to 5.5 and 3.1 to 10). Therefore, all sub-ranges of all ranges expressly disclosed herein are hereby expressly disclosed.

As used herein the term ‘(s)’ following a noun means the plural and/or singular form of that noun. As used herein the term ‘and/or’ means ‘and’ or ‘or’, or where the context allows, both.

This invention may also be said broadly to consist in the parts, elements and features referred to or indicated in the specification of the application, individually or collectively, and any or all combinations of any two or more said parts, elements or features. Where specific integers are mentioned herein which have known equivalents in the art to which this invention relates, such known equivalents are deemed to be incorporated herein as if individually described.

Furthermore, in this specification if/where reference has been made to patent specifications, other external documents, or other sources of information, this is generally to provide a context for discussing features of the invention. Unless specifically stated otherwise, reference to such external documents or sources of information is not to be construed as an admission that such documents or such sources of information, in any jurisdiction, are prior art or form part of the common general knowledge in the art.

### Statements of Invention

According to one aspect of the present invention, there is provided a monitoring system associated with the operation of a dairy plant, said system being adapted or able to monitor one or more of the following criteria:
a. the mixing and/or dispensing of animal health products,
b. the mixing and/or dispensing of teat treatments,
c. the mixing and/or dispensing of chemicals,
d. the mixing and/or dispensing of cleaning chemicals,
e. the monitoring of plant cleaning operations,
f. the usage of plant products/treatments/chemicals,
g. any other aspects associated with the operation of a dairy plant.

According to another aspect of the present invention, there is provided a monitoring system, substantially as described above, wherein said monitoring system is adapted or able to monitor a dispensing system for dispensing chemicals, said dispensing system including:
a. at least two storage reservoirs, each for containing a respective chemical solution,
b. a water source,
c. a mixing system,
d. a dosing system coupled to the storage reservoirs and to the water source, for selectively dispensing one or more of the chemical solutions and water into the mixing system to form a mixed solution,
e. a user interface for receiving dispensing instructions from a user,
f. a controller for operating the dosing system in accordance with the dispensing instructions,
g. a sensor in communication with the controller, configured to measure a property of at least one dispensed chemical solution and/or of the mixed solution,
   wherein the controller is configured to log information from the sensor in a database.

According to another aspect of the present invention, there is provided a monitoring system, substantially as described above, wherein the chemical solutions include one or more of: a teat wash or mastitis treatment, a detergent, an acid plant wash, and/or an alkali plant wash, and/or one or more animal health products, and/or a mineral supplement.

According to another aspect of the present invention, there is provided a monitoring system, substantially as described above, wherein a first one of the storage reservoirs comprises a teat wash or mastitis treatment, and a second one of the reservoirs comprises a detergent and/or an acid plant wash, and/or an alkali plant wash.

According to another aspect of the present invention, there is provided a monitoring system, substantially as described above, wherein the sensor is configured to measure one or more of the volume, concentration, temperature, and/or pH of a solution in the mixing system.

According to another aspect of the present invention, there is provided a monitoring system, substantially as described above, wherein the user interface enables a user to select the chemical solution(s) to be mixed and to specify the strength, volume, or application of the mixed solution.

According to another aspect of the present invention, there is provided a monitoring system, substantially as described above, wherein the user interface enables a user to specify the application for the mixed solution, and wherein for a given specified application, the controller retrieves one or more of the required volume or strength of the mixed solution.

According to another aspect of the present invention, there is provided a monitoring system, substantially as described above, wherein the user interface can also be used for re-ordering product, and/or confirming the use of safety PPE, and/or for alerting the operator to measurements outside set parameters.

According to another aspect of the present invention, there is provided a monitoring system, substantially as described above, wherein the mixing system includes an outlet coupled to a spray system for spraying cow udders for mastitis treatment.

According to another aspect of the present invention, there is provided a monitoring system, substantially as described above, wherein the system further includes a temperature sensor placed in a suitable position at a waste water outlet of the dairy plant wash or spray system, to measure the temperature of the wastewater.

According to another aspect of the present invention, there is provided a monitoring system, substantially as described above, wherein the system further includes one or more chemical level sensors arranged to sense the quantity of chemical solution remaining in a respective storage reservoir.

According to another aspect of the present invention, there is provided a monitoring system, substantially as described above, wherein the controller is configured to receive sensed data from the chemical level sensors and transmit this data to a remote location.

According to another aspect of the present invention, there is provided a monitoring system, substantially as described above, wherein the controller is configured to receive sensed data from the chemical level sensors, and calculate a quantity of one or more chemical solutions used in a given time period.

According to another aspect of the present invention, there is provided a monitoring system, substantially as described above, wherein the system further includes a module to generate an invoice from data in the database, wherein the invoice invoices for a quantity of chemical solution(s) used in a given period.

According to another aspect of the present invention, there is provided a monitoring system, substantially as described above, wherein the controller is configured to receive sensed data from the chemical level sensors and, when the sensed quantity of chemical solution remaining in a respective storage reservoir is below a threshold amount, to transmit this data to a remote location and/or produce an alert on the user interface.

According to another aspect of the present invention, there is provided a monitoring system, substantially as described above, wherein the controller is configured to receive sensed data from the chemical level sensors and, when the sensed quantity of chemical solution remaining in a respective storage reservoir is below a threshold amount, to transmit an order for replenishment of said chemical solution to a supplier of the chemical solution.

According to another aspect of the present invention, there is provided a monitoring system, substantially as described above, wherein before transmitting the order for replenishment of said chemical solution, the controller obtains approval for the order via the user interface.

According to another aspect of the present invention, there is provided a monitoring system, substantially as described above, wherein the controller is configured to record one or more of:
(a) a measured property of at least one dispensed chemical solution,
(b) a measured property of the mixed solution along with the time and date,
(c) information about the type of solution mixed,
(d) instructions input by user via the user interface,
(e) information about use of the mixed solution,
in the database, alongside date and time data, and batch number.

According to another aspect of the present invention, there is provided a monitoring system, substantially as described above, wherein the mixing system is configured to supply fluid from the mixing system to a wash or spray system for washing a dairy plant, and/or for spraying cows udders for mastitis treatment, and the system controller is configured to log the volume and strength of fluid dispensed to the dairy plant wash or spray system, along with the time and date the fluid was dispensed.

According to another aspect of the present invention, there is provided a monitoring system, substantially as described above, wherein the controller is further configured to receive and log a temperature measurement from a temperature sensor at a waste water outlet of the dairy plant wash or spray system (no temperature is measured at the end of the spray system).

According to another aspect of the present invention, there is provided a monitoring system, substantially as described above, wherein the controller is configured to wirelessly communicate data to the cloud or to a remote server.

According to another aspect of the present invention, there is provided a monitoring system, substantially as described above, wherein the mixing system includes an outlet and a sensor to measure the amount of the mixed solution dispensed through the outlet.

According to another aspect of the present invention, there is provided a monitoring system, substantially as described above, wherein the dosing system includes one or more pumps for pumping the chemical solutions to the mixing system.

According to another aspect of the present invention, there is provided a monitoring system, substantially as described above, wherein each storage system is fluidly connected to a pump.

According to another aspect of the present invention, there is provided a monitoring system, substantially as described above, wherein the system further includes a plurality of mixing systems, wherein the system is configured to dispense different chemical solutions into different mixing systems.

According to another aspect of the present invention, there is provided a monitoring system, substantially as described above, wherein a first one of the mixing systems is configured to receive a teat wash or chemical solution for mastitis treatment and water, and a second one of the mixing systems is configured to receive a detergent and/or wash chemical and water.

An automated method for mixing chemicals for washing a dairy plant using the monitoring system substantially as described above, said method including the steps of:
a. obtaining desired mixture parameters from a user via the user interface,
b. dispensing water from the water source and an acid or alkali concentrate into a mixing system to create a mixed solution in accordance with the parameters,
c. measuring the pH level of the solution in the mixing system,
d. logging the pH level in a database,
e. measuring the temperature of the wastewater at the plant wash outlet, and
f. logging the wastewater temperature in the database.

According to another aspect of the present invention, there is provided a method, substantially as described above, wherein the method further includes a means for issuing an alert if the pH level is outside a pre-determined allowable range.

According to another aspect of the present invention, there is provided a method, substantially as described above, wherein the method further includes a means for issuing an alert if the wastewater temperature is below a pre-determined minimum temperature.

According to another aspect of the present invention, there is provided a method, substantially as described above, wherein the method further includes the step of recording in the database, alongside date and time data, one or more of:
(a) a measured volume of the dispensed acid or alkali concentrate,
(b) a measured volume or concentration of the mixed solution,
(c) information about the type of solution mixed,
(d) instructions input by user via the user interface,
(e) information about use of the mixed solution,
(f) the level of acid or alkali concentrate remaining in the respective storage reservoir,
(g) information about the pH of the mixed acid or alkali solution prior to the wash being started,
(h) information about the temperature of the mixed acid or alkali solution after the wash has been completed,
(i) information about the time taken for the plant wash to be carried out,
(j) information about the time taken for the vat wash to be carried out

According to another aspect of the present invention, there is provided a method, substantially as described above, wherein the method further includes the steps of:
obtaining desired mixture parameters from a user via the user interface,
dispensing water from the water source and a teat treatment concentrate from one of the storage reservoirs, into the mixing system to create a mixed solution in accordance with the parameters,
applying the mixed solution, directly or indirectly, to animal teats, recording in the database, alongside date and time data, one or more of:
(a) a measured volume of the dispensed teat treatment concentrate,
(b) a measured volume or concentration of the mixed solution,
(c) the volume of the mixed solution dispensed,
(d) information about the type of solution mixed,
(e) instructions input by user via the user interface,
(f) information about use of the mixed solution,
(g) the level of teat treatment concentrate remaining in the respective storage reservoir.

According to another aspect of the present invention, there is provided a monitoring system, substantially as described above, wherein the monitoring system is further adapted, or able, record any, or all, data obtained through said monitoring.

According to another aspect of the present invention, there is provided a monitoring system, substantially as described above, wherein the monitoring system is further adapted, or able, to generate an alert when certain readings/measurements and/or conditions are met (or not met)—the ‘readings/measurements and/or conditions’ being collectively referred to herein as ‘the event(s)’.

According to another aspect of the present invention, there is provided a monitoring system, substantially as described above, wherein the alert(s) is capable of being automatically generated before, during and/or after the occurrence of the event(s).

According to another aspect of the present invention, there is provided a monitoring system, substantially as described above, wherein the alert(s) is capable of being automatically generated in real time—with respect to the occurrence of the event(s).

According to another aspect of the present invention, there is provided a monitoring system, substantially as described above, wherein the alert is automatically delivered by email, and/or via an app, and/or via a text message to a user of the monitoring system.

According to another aspect of the present invention, there is provided a monitoring system, substantially as described above, wherein the alert enables a user of the monitoring system to immediately investigate the event(s) and/or the cause(s) of the event(s).

According to another aspect of the present invention, there is provided a monitoring system, substantially as described above, wherein the alert enables the user of the monitoring system to immediately remedy the cause(s) of the event(s).

According to another aspect of the present invention, there is provided a monitoring system, substantially as described above, wherein the monitoring system is further adapted, or able, to transmit any, or all, of said data to a remote location.

According to another aspect of the present invention, there is provided a monitoring system, substantially as described above, wherein the monitoring system is further adapted, or able, to transmit any, or all, of said data to a remote computer/device and/or a computer server and/or a cloud computing system.

According to another aspect of the present invention, there is provided a monitoring system, substantially as described above, wherein said real time alert(s) may include one or more of the following:
a. An alert on the temperature of the waste water post washing,
b. An alert on the pH of the wash water prior to washing,
c. An alert on the level of chemical remaining in a storage drum,
d. An alert on chemical concentrate mixed if out of parameter,
e. An alert on teat spray mixed if out of parameter,
f. An alert on the bulk milk somatic cell count of milk supplied,
g. An alert on the bactoscan level in milk supplied,
h. An alert on the coliform bacteria level in milk supplied,
i. An alert on the thermoduric bacteria level in milk supplied,
j. An alert based on ratio calculations from the data, where ratios fall outside a set parameter,
k. A power failure somewhere in the shed or within the monitoring system,
l. A failure or malfunction of any component of the monitoring system.

According to another aspect of the present invention, there is provided a monitoring system, substantially as described above, wherein the data for points f, g, h and i above may be accessed via an external source and can be displayed on the user interface or an alert can be sent to relevant parties when the data falls outside set ranges.

### Preferred Embodiments

The description of a preferred form(s) of the invention to be provided herein, with reference to the accompanying drawings, is given purely by way of example and is not to be taken in any way as limiting the scope or extent of the invention.

### DRAWINGS

FIG. 1 is a schematic showing a first embodiment system for dispensing chemicals,

FIG. 2 is a schematic showing a second embodiment system for dispensing chemicals,

FIG. 3 shows an exemplary screen of a user interface providing a user with options for initiating the mixing and dispensing various solutions,

FIG. 4 shows an exemplary screen of a user interface a user can use to select a type of solution for which they want to specify the mixing settings,

FIG. 5 shows an exemplary screen of a user interface for specifying requirements for mixing a teat treatment mixture,

FIG. 6 shows an exemplary screen of a user interface for specifying requirements for mixing a dairy plant wash solution,

FIG. 7 shows an exemplary screen of a user interface for calibrating a sensor of the system,

FIG. 8 shows an exemplary screen of a user interface showing the status of the chemical storage reservoirs, and providing options to re-order stock before the reservoir is depleted,

FIG. 9 is a flow chart illustrating a method for mixing a teat treatment spray using the system of FIG. 2,

FIG. 10 is a flow chart illustrating a method for mixing an alkali plant wash solution for using the system of FIG. 2; and

FIG. 11 is a flow chart illustrating a method for mixing a plant acid wash using the system of FIG. 2.

FIG. 12 is a high level flow chart illustrating the various programs that can be selected on the user interface

### DETAILED DESCRIPTION OF PREFERRED EMBODIMENTS

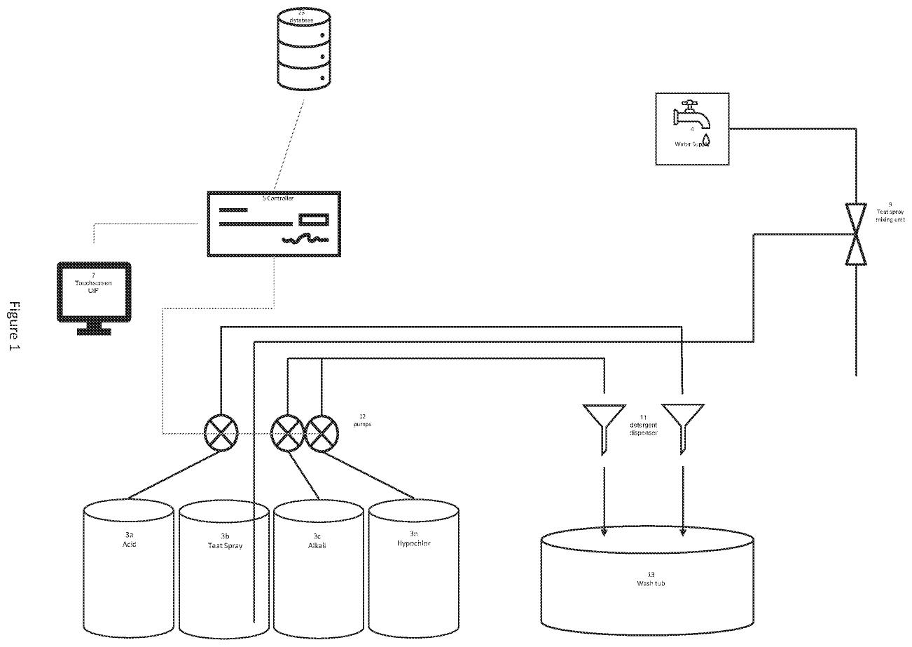

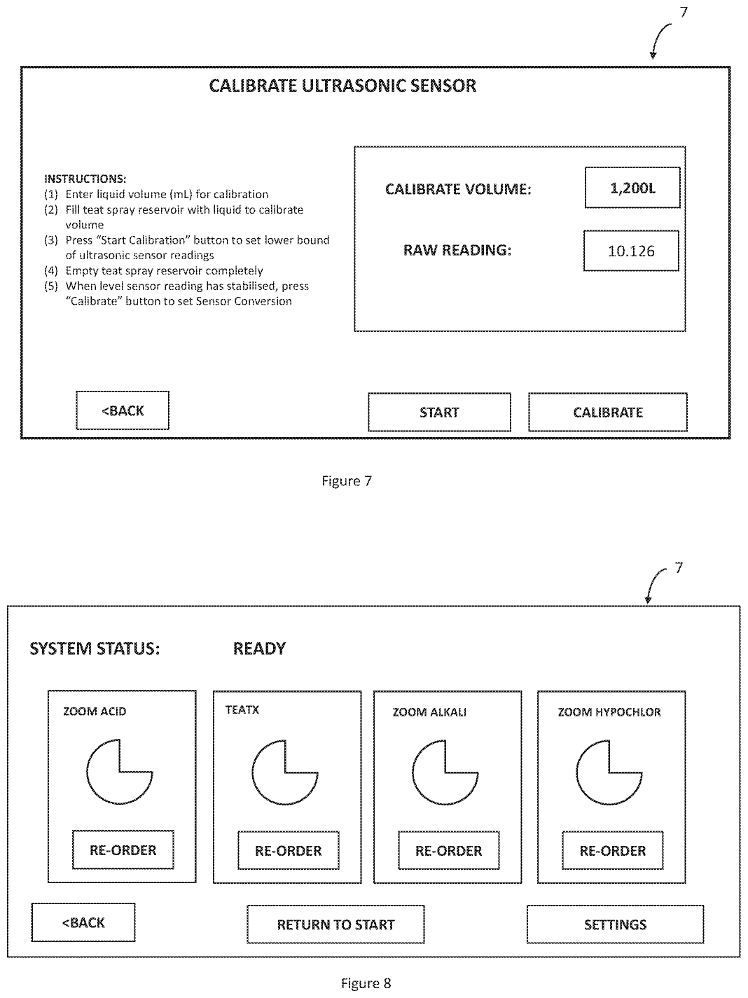

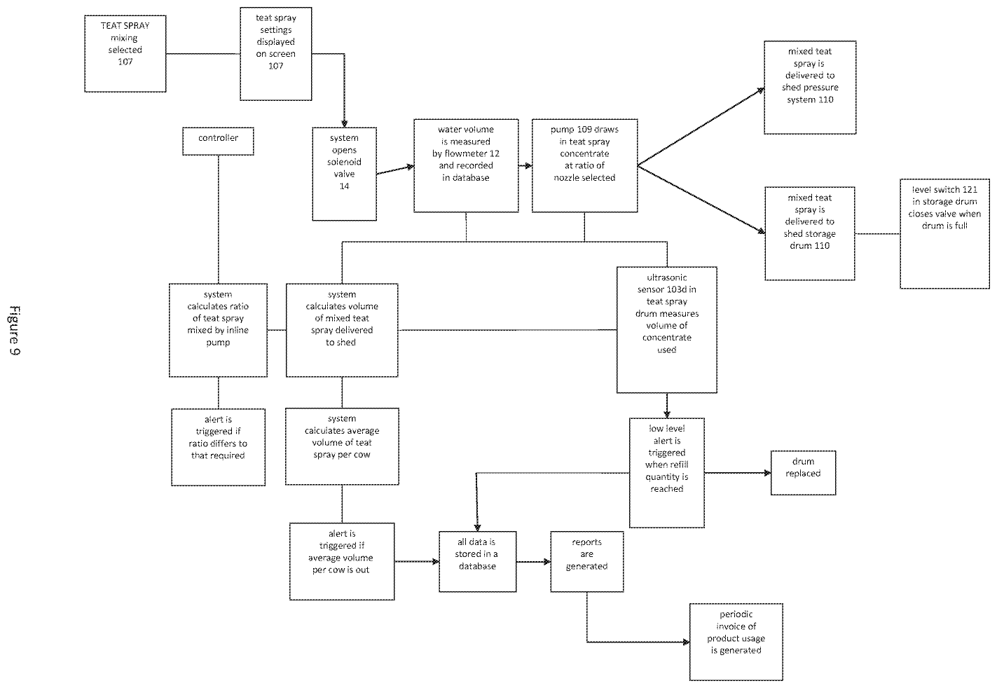

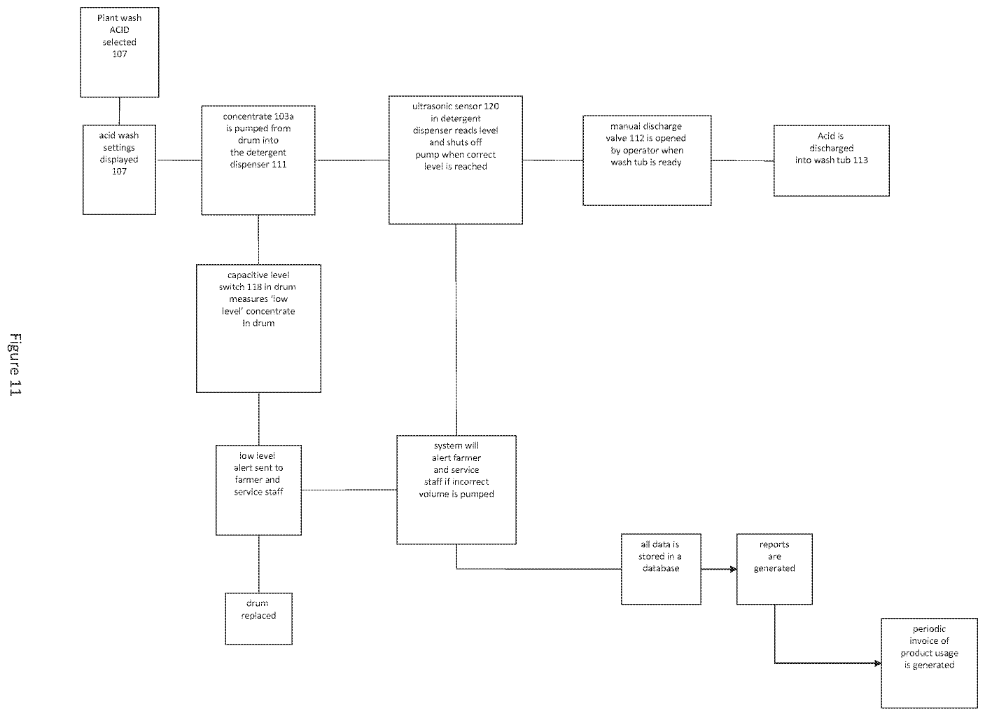

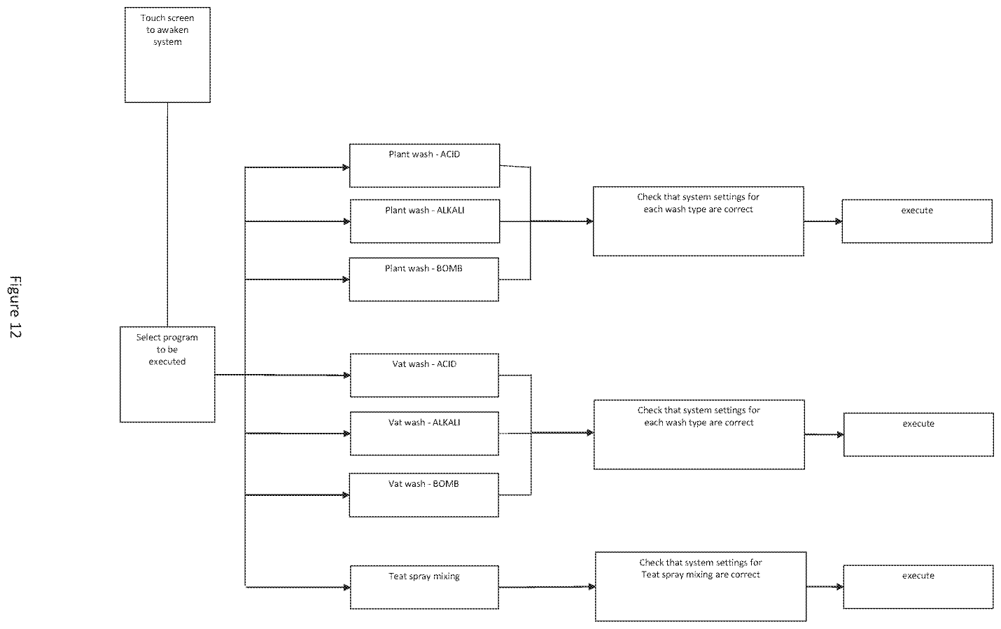

While the present invention may be embodied in many different forms, for the purpose of promoting an understanding of the principles of the present invention, reference will now be made to FIGS. 1 to 11 which show an exemplary embodiment systems and methods.

FIG. 1, illustrates a first embodiment monitoring system 1 for monitoring the dispensing of chemicals. The system 1 comprises at least two storage reservoirs, 3a 3b, 3c, 3n, each for containing a respective chemical solution, and a water source 4. The system 1 shown comprises four storage reservoirs 3a 3b, 3c, 3n, but alternatively the system 1 may have more or fewer reservoirs. The water source 4 may comprise a mains water connection or a water tank, for example.

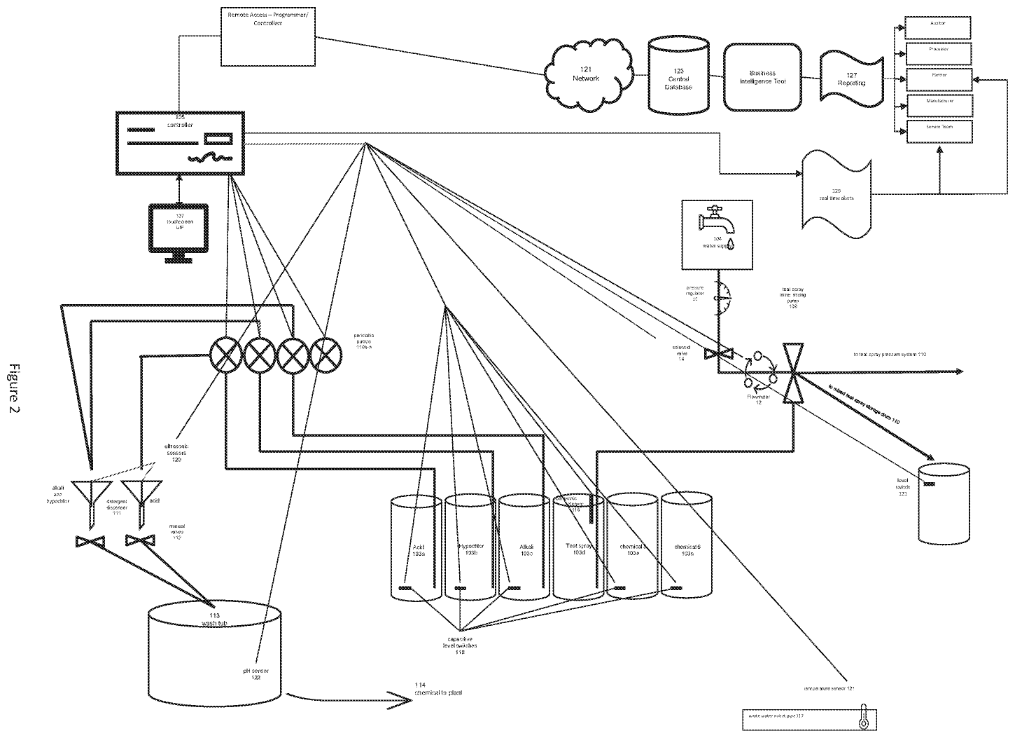

The system 1 further comprises a dosing system 11 of detergent dispensers coupled to selected storage reservoirs 3a 3b, 3c, 3n and to the water source 4, for selectively dispensing the chemical solutions and water into mixing reservoirs, 13, to form a mixed solution. The dosing system 11, 9 comprises a network of pumps, valves, and conduits (not shown), with a controller 5 and a user interface 7 configured to operate the dosing system 11 in accordance with instructions selected on the user interface 7 by an operator. The dosing system 11 is described in more detail below in relation to the embodiment of FIG. 2.

The system 1 is envisaged for, but not limited to use in, a dairy milking shed/plant.

In a dairying application, the storage reservoirs, 3a 3b, 3c, 3n may typically comprise one or more drums of: a teat wash or mastitis treatment concentrate, a detergent, an acid plant wash concentrate, and/or an alkali plant wash concentrate, a mineral supplement, and/or any animal health/treatment product(s).

The storage reservoirs 3a 3b, 3c, 3n are stored at or adjacent to the dairy shed site, in an area(s) fit for chemical storage in accordance with local regulations.

FIG. 2 shows a second embodiment monitoring system 101, for monitoring the dispensing of chemicals, similar to the monitoring system 1 of FIG. 1. Unless otherwise stated, like numbers are used to indicate like parts, but with the addition of 100.

In this second embodiment, a flexible plastic tube is placed and secured in each storage reservoir 103a to 103n, such that the chemical solution in the drum 103a to 103n is drawn by the respective pump 119a-n and pump 109. Each storage reservoir 103a to 103n is fluidly connected to a detergent dispenser 111 or a mixing pump 109 via a respective pump 119a to 119n, or directly, and one or more conduits, to draw the respective chemical concentrate/solution from the storage reservoirs 103a to 103n, into the detergent dispensers 111 or the mixing pump 109.

Essentially, the detergent dispensers 111 and mixing pump 109 are measuring cylinders where chemical concentrate housed within the storage reservoirs 103a to 103n is pumped, or drawn into—by the pumps 119a to 119n and the mixing pump 109—and accurately measured by the level sensors 120 and the liquid ratio mixing technology in the mixing pump 109. Once the correct amount of chemical concentrate is pumped into the detergent dispensers 111 the system shuts the pumps 119a to 119n down.

The chemical concentrate is then dispensed into the wash tub 113 where it mixes with water received from the plant hot or cold water cylinders. The detergent dispensers are fitted with manually operated valves 112 where the operator opens the valve when the concentrate is required in the wash tub 113.

The pumps 119a to 119n may be any suitable pump, for example a peristaltic pump. The pumps 119a to 119n are electrically connected to a power source and are operated by the system controller 105. The controller 105 activates the required pump or pumps and controls the length of time the pump runs for. The pump(s) is/are turned off (shut down) when the level of chemical concentrate in the detergent dispenser 111 reaches the correct level (determined by the inputs) as read by the level sensors 120.

The amount of chemical concentrate required is not determined by the length of time the pump(s) run. The pump(s) may run at different speeds depending on factors such as outside temperature, liquid viscosity etc. A more accurate method of measuring the chemical concentrate dispensed is by using the sensors in the detergent dispensers 111.

Each pump runs for any length of time, for example, depending on the required volume of chemical to be drawn from each drum 103a to 103n. The pumps may operate at a known fluid displacement rate, or the system may measure the amount of fluid displaced by the pumps and operate the pumps in response to that measurement. The controller would not ordinarily control the pump speed. Instead, the pumps will run automatically until the readings from the level sensors show that the desired volume has been reached, and then the pumps will be shut down.

The system controller 105 and the pumps 119a to 119n can be housed together in a controller housing. However, alternatively the pumps may be housed separately to the system controller 105. The pumps may be housed and configured separately, or together, depending on the layout of the shed and the placement of the drums 103a to 103n relative to the shed.

The conduits preferably comprise flexible piping, however, alternatively the conduits or portions of the conduits may be rigid pipes or other suitable conduits. The length and configuration of the conduits will depend on the configuration of the dairy shed and the location of the reservoirs. Each shed installation may require different piping lengths and configurations. A permanent water supply 104, such as a water mains, is fluidly connected to the teat spray inline mixing pump 109.

The chemical management system 101 may comprise one or several mixing reservoirs. In the embodiment 101 of FIG. 2, one mixing reservoir 113, is provided and one mixing pump 109 is provided. Mixing reservoir 110 forms part of the plant equipment and is not a component of the monitoring system. The mixed teat spray storage drum 110 stores mixed teat spray ready for use in the dairy shed.

Where a system comprises multiple mixing reservoirs, or multiple detergent dispensers, the system may be configured to dispense different chemical solutions into different mixing reservoirs. That is, each chemical storage reservoir may be plumbed to supply fluid to a particular reservoir, depending on the end use of the chemical in the storage reservoir.

In the embodiment of FIG. 2, a first mixing reservoir 109 is in the form of an inline mixing system where chemical concentrate and water is constantly drawn at the same time and in the right ratio while the teat spray operations in the shed is/are underway. As such, this inline mixing system, is fluidly connected to the water supply 104 and a storage reservoir 103d that holds a teat spray concentrate. The mixed teat spray is stored on a storage drum 110 ready for use in the dairy shed or delivered directly to the teat spray pressure system of the shed. The storage drum 110 will often be a shed component.

A second mixing reservoir 113 is in the form of a wash tub, for mixing wash solutions for cleaning dairy shed plant equipment and the dairy milk vats. The wash tub 113 is a component of the dairy shed and not a component of the monitoring system 101.

The wash tub 113 is connected to the shed water supply (for cold washes), and for hot washes the wash tub 113 receives its hot water from shed hot water cylinders. So, for a plant or milk vat hot wash the hot water in the cylinder is dispensed into the wash tub 113 and the chemical concentrate will be dispensed into the wash tub 113 thereafter via the detergent dispensers 111. Likewise, for a cold wash, the wash tub 113 will receive its cold water from the shed water supply and the chemical concentrate will be dispensed into the wash tub 113 thereafter via the detergent dispensers 111. The wash tub 113 is indirectly connected to the water supply 104 and to storage reservoirs 103a, 103b, 103e containing wash chemical concentrates, for example an alkali concentrate, an acid concentrate, and a detergent.

The volume of acid and alkali chemical concentrate is measured in the detergent dispensers 111 and dispensed into the wash tub 113 where the mixed chemical is used by the plant and milk vat cleaning system.

Each process generates information, and this data is stored in the controller 105, and/or in a central database.

For example (only), information gathered from an acid wash programme would typically be wash type (i.e., programme selected), time, date, chemical quantity used, chemical quantity remaining in drum, wash water pH, waste water temperature.

Likewise, information gathered from an alkali wash programme would typically be wash type (i.e., programme selected), time, date, chemical quantities used, chemical quantities remaining in drum, wash water pH, waste water temperature.

Information gathered from a teat spray mixing programme would typically be programme selected, time, date, chemical quantity used in mix, water quantity in mix, number of cows milked, teat spray mixing ratio, average quantity applied per cow.

For all of the above, the monitoring system 101 can calculate (but is not limited to) cumulative number of washes by type, cumulative quantities used per chemical, cumulative number of cows milked, average quantity applied per cow on a cumulative basis, average pH of wash water per wash type over time, average temperature of waste water over time. Information such as average SCC (somatic cell count) over time, and average Bactoscan over time can be sourced from the milk processor, and can be published by the monitoring system in the form of (electronic) reports or screen messages on the user interface.

In addition, the system can retrieve milk quality information from a processor, namely bactoscan, thermoduric, coliform, BMSCC which can be reported back to the users and an alert triggered should the results be outside applicable scores, and then remedial action prompted to the user and chemical supplier.

The system can be expanded to include further mixing reservoirs, such as that for animal health products where the process of supplying such products to the mixing reservoirs is the same, or similar, as that for shed cleaning chemicals.

These further mixing reservoirs can be in the form of a drum and may be provided for the mixing of animal health products. These reservoirs are fluidly connected to the storage reservoirs 103e and 103n containing bloat control concentrate and a liquid trace mineral blend for dairy cows respectively. The user will select the programme from the user interface 7 instructing the controller to mix a bloat solution or a mineral solution. The controller will start the pump and concentrate will be pumped from the storage reservoir to the mixing unit. A flow meter, or other volume measuring device, between the pump and the mixing drum will measure the amount of concentrate pumped and when the desired quantity has been reached communication between the flow meter, or measuring device, and the controller will stop the pump. The mixed liquid in the reservoir will be taken to the farm's water troughs by the farms water delivery system. The same process will be followed for the mixing and delivery of the liquid trace mineral blend.

In each of these processes the quantity of concentrate used for mixing will be monitored, measured and recorded, date and time of mixing will also be recorded as will be the instructions requested on the user interface 107.

In the embodiment shown, each storage reservoir 103a-n is plumbed to separate mixing reservoirs or detergent dispensers. One or more additional pump(s) and associated conduits may supply fluid to additional mixing reservoir(s), or a valve may be positioned downstream of the pump 119a-n that is adjustable to alter the flow path of fluid drawn from the storage reservoir 103a-103n.

Detergent dispensers 111 may be provided upstream of one or more of the mixing reservoirs 113. These detergent dispensers 111 comprise a sensor, such as an ultrasonic sensor, in communication with the system controller 105, for measuring the level of fluid in the detergent dispensers 111. The detergent dispensers 111 comprise a simple inlet to connect piping, and a manual outlet valve 112. The discharge valve 112 is controlled by the shed operator between a closed state for containing and measuring fluid quantities in the detergent dispensers, and an open state for discharging fluid from the detergent dispensers into the downstream mixing reservoir such as the wash tub 113.

The detergent dispensers 111 receive chemicals separately via the piping connected to pumps 119a-n and according to the chemical mixing programme selected by the operator.

Mixing reservoir, 113 will comprise an outlet, 114 for the discharge of the mixed solution for the shed cleaning process.

For example, the wash tub 113 comprises an outlet 114 that can be opened or closed and that is coupled to a wash system for cleaning a dairy shed, to supply fluid from the mixing reservoir to the wash system.

That said, the monitoring system 101 is not overly concerned, or affected by, how the mixed solution in the wash tub 113 is pumped around the components of the dairy shed—each shed may be set up in a slightly different way and the mixed solution may be drawn from the wash tub 113 in a slightly different way. The monitoring system 101 is more concerned with mixing the correct amount of acid, or alkali, to the water volume in the wash tub 113, and recording these measurements, and alerting on any measurements that fall outside set parameters.

The inline mixing system 109 has an outlet 110 coupled to a pressurised spray system for application of the mixed teat spray. This outlet 110 can also be coupled to a drum the shed uses to store mixed teat spray ready for use. This storage drum can be fitted with a level switch 121 which communicates with the controller. When the mixed teat spray storage drum reaches its full level as indicated by the level switch 121, the controller shuts the valve 14 and no more teat spray is mixed.

The mixing reservoirs 113 may each comprise one or more sensors for providing information about the solution in the mixing reservoir to the system controller 105. The sensors may measure a property of at least one dispensed chemical solution and/or of the mixed solution. For example, sensors may measure the quantity of chemical solution dispensed, the volume, temperature, concentration, or pH of the solution in the mixing reservoir 113,

Where the system 101 is for monitoring the dispensing of chemical concentrate for a plant wash, the wash solution dispensed from the wash tub 113 is then circulated through the plant by the shed wash system. Wastewater from the wash is typically discharged through a plant wastewater outlet pipe 117. A temperature sensor 121 may be provided at the wastewater outlet 117, or another suitable position, to measure the temperature of the wastewater. The temperature sensor 121 is in communication with the system controller 105.

Milk quality issues are sometimes related to lower than optimum water temperature washing the plant and/or exiting the plant wash system after a wash. For example, if the waste water is below 60° C. for a plant wash and below 56° C. for a milk vat wash, this is less than optimal—and an alert may therefore optionally be generated, either during or after the wash cycle—if the latter, preferably immediately after.

Milk quality issues may further be attributed to the length of time hot water circulates the plant prior to being discharged as waste water. If the length of time in circulation is regularly too short the residues, fats and oils may not be cleaned sufficiently in the pipelines. The system will monitor and record the length of time of each wash, with the recommended time being 5-7 minutes. Where wash time is less than 5 minutes, the system will alert the farmer and service staff.

The monitoring system 101 may generate alerts for example an audible and/or visual alert and/or a warning message.

For example, an alert(s) may be displayed on the user interface and/or be transmitted to a remote location and/or device—such as a pager or an app (e.g., a smartphone app), a computing device and/or a cloud computing system—if any measurement from a sensor or from a calculation in the system 101 is outside a predetermined allowable range. This provides an opportunity for the operator/farmer (and/or service team) to investigate any anomaly with the system, a mixed solution, or the plant or vat wash, and correct this to avoid milk quality being adversely affected by an inadequately cleaned plant or herd not being correctly treated.

The alerts may be generated and/or sent at any time, for example, before, during or after whenever any adverse reading or measurement relating to any criteria or event is taken and/or recorded.

If any such alerts are generated and/or sent after any adverse reading/measurement, as described above, then the alert may preferably be generated immediately afterwards—which is effectively in real time.

Such an alert system may therefore be adapted to detect a potential milk quality issue, and/or dairy plant issue, immediately—and hence remedial action may also be taken immediately.

For example, various sensors will generate alerts if their readings during a plant or milk vat wash, chemical mix, or teat spray mixing execution fall outside pre-set parameters. Farmers can then act on these alerts as they arise, rather than work as normal only to find out 4-5 days later that their milk quality has been compromised and/or that their milk has been rejected and/or that their milk payment has been reduced and/or that an audit to their plant has to be carried out.

Hence, it is the collective working together of each/all of the various components of the monitoring system 101 (e.g., sensors/controllers/data recorders), combined with the alert system, that renders this system 101 synergistically advantageous over any known prior art systems, and significantly so.

Each storage reservoir, 103a 103b, 103c, 103n has an associated sensor to measure a property indicative of the level of the solution remaining in the reservoir. The sensor may measure a quantity/amount of fluid in the reservoir or may sense a binary value such as if the fluid is above a certain level. For example, each drum may have one or more level sensors, to measure when the chemical level reaches a pre-determined level in the drum.

Alternatively, one or more level switches may be fitted to each storage drum 103a-103n and these switches are easily removed from an empty drum and refitted on to a new drum. When the level of product in the drum reaches the level switch an alert will be sent to the farmer or service staff who can then place an order for a replacement drum using the interface 107.

Alternatively, the monitoring system 101 may comprise/include a sensor for measuring the weight of each storage reservoir and whereby the amount of product remaining in each storage reservoir is determined by monitoring changes in the weight of the storage reservoir. Each sensor communicates with the system controller 105 either by way of a wired connection or wirelessly.

Alternatively, the controller 105 may be configured to estimate the remaining chemical in each storage reservoir based on usage data history and a known starting volume of the reservoir.

Alternatively, capacitive level switches 118 may be fitted to each storage reservoir 103a to 103n which detect the volume of the liquid in the reservoir. When the volume reduces below this level switch it communicates with the controller 105 by way of a wired connection and the controller alerts the farmer or service staff that a reservoir (drum) is near empty and requires replacing.

When the chemical concentrate volume in a given storage reservoir 103a to 103n reaches a pre-determined level, or the change in weight of the reservoir is greater than a pre-determined threshold amount, this indicates that the volume of chemical solution remaining in the reservoir is getting low and may need to be replenished. The system controller is configured to produce an alert, or warning when that occurs. The alert may be sent to the dairy shed operator/farmer, for example via the user interface, or via a warning light such as an LED provided near the user interface or on or alongside the respective storage reservoir. Additionally, or alternatively, the system controller 105 may send an alert to a remote location, for example, to a third party like a supplier or retailer or sales/service staff or support team, to communicate that the level is low—and whereby appropriate remedial action may be taken.

Preferably, but not essential, the level sensors or switches detect at least two pre-determined chemical levels—a first level to indicate that the volume in the storage reservoir 103a-n is approaching a low level, to warn the farmer/operator and/or the service staff, and a second level to detect that the reservoir is empty or near empty.

The system controller 105 is connected to a network, for example the internet or other wide area network, to enable the storage of data in a database and/or on a remote server and/or in the cloud. The controller 105 preferably also comprises non transient local storage, such as by way of an internal hard drive or a removable solid-state drive such as provided via a USB device.

Data generated by the system 101 is stored locally and/or is transmitted to the remote database. The system controller 105 is configured to record one or more of: a measured property of at least one dispensed chemical solution or of the mixed solution, such as measured pH, temperature, concentration, quantity, and type of mixtures dispensed or of wastewater from the plant wash system; information about the type of solution mixed; instructions input by user via the user interface; or information about use of the mixed solution. This data is logged in the database 123, alongside date and time data.

The system controller 105 also logs the temperature measurement from the temperature sensor at a waste-water outlet 117, or other suitable position, of the dairy shed wash or spray system.

Data from the database 123 may be utilised to monitor the performance and compliance of a dairy shed with best practice. Data logged in the database 123 may be fully or partly accessible by approved third parties, for example by milk quality auditors, milk processors/companies. The database can be used to generate customised reports to reliably monitor the compliance of sheds in their cleaning chemical and teat spray use, estimate the potential for reduced milk quality, and provide business intelligence.

Milk quality auditors do not currently have any access to historical shed wash and chemical mix data prior to auditing a shed (they could potentially request historical information from the hardcopy data entered into the daily shed diary. However, detailed information about the amount of chemical used for plant and vat washes, and teat spray is not necessarily recorded in the daily diary. They will enter milk temperature data on a daily basis).

Auditing typically requires a lengthy site visit and reviewing manual records of shed wash and chemical mix data. Such records may be inaccurate, contain omissions, or may even be fabricated. The present system enables much more reliable auditing data around chemical use and for much of the auditing to be done remotely, saving valuable time for both the auditor and farmer. The system 101 can be configured to require the input of daily information before carrying out any further tasks. This ensures records are kept up to date (this could also be around the confirmation of wearing the required PPE before handling the chemicals—staff safety reasons and awareness).

The real-time feedback, automated mixing of chemicals, alerts, and the ability to auto-replenish (order) chemicals advantageously means the farmer is less likely to inadvertently mix or apply wash or treatment chemicals in an incorrect and/or ineffective manner, improving hygiene in the shed and thereby improving milk quality.

Real time alerts can, for example only, be triggered for the following reasons:
1. Low chemical in storage reservoir (drum) 103a to 103n
   A level switch is calibrated and fitted to the outside of each storage drum 103a-103n that can detect a pre-determined chemical level. When the level is reached the sensor will trigger an alert to the farmer/shed staff/sales person etc., indicating that the level has reached the low point. Message delivery can be via email, over an app, or simple text message to a mobile phone etc. The farmer can make an immediate decision to order and replenish the near empty drum. This can be done by calling the sales person or simply executing the new order using the user/app/phone interface. The sales person can also make contact with the farmer to confirm the new order and drum replenishment.
   The teat spray storage drum 103d will be fitted with an ultrasonic sensor that has the ability to supply accurate information on the amount of product in the drum. When the product reaches a predetermined low level, the sensor will transmit information to the controller and an alert sent out to the farmer or service staff for the replacement of the drum.
   There are instances in dairy sheds where drums run out of chemical and shed staff may not place an order timely enough causing suboptimal plant and milk vat washes. This can typically lead to milk quality downgrades.
   Advantage of this real time alert, and because more than one person can receive the alert, is the likelihood of the chemical drum not being replaced on time is greatly minimised, ensuring continuity of optimal plant and milk vat washes and minimising the possibility of reduced milk quality, and avoiding the resultant penalties and/or disadvantages associated with that event.
   The same applies for the teat spray chemical drum, namely, reducing the possibility of chemical run out, thus ensuring all cows in the herd are treated correctly for the control of mastitis. Cows not sprayed with teat spray at the end of each milking may be susceptible to an increased incidence of mastitis, and this can again lead to reduced milk quality.
2. Chemical dosed out of range
   In the event of there being a situation where the chemical volume measured in the detergent dispenser and dosed into the wash tub 113, or the teat spray mixing drum 110 in the case of teat spray is the incorrect ratio, and falling outside a predetermined range, the system 101 will trigger an alert informing the farmer, shed staff, or service staff. This will not stop the shed cleaning or teat spraying process, but the reasons for the incorrect dose can be investigated immediately and rectified prior to the next chemical mixing programme. This ensures the correct concentration of chemical is mixed immediately thereafter—thus returning the plant, and milk vats to optimal washes, and correct teat spray ratios.
3. Temperature of the waste water
   a. For the plant
      In order for dairy shed cleaning chemicals to be effective they require an optimised combination of chemical concentration, temperature, turbulence and time in the cleaning process. The system 101 can monitor/measure the temperature of the waste water immediately after the plant wash is completed. This temperature should preferably not be lower than 60° Celsius. Any temperatures lower than this, on a continuous basis, could lead to sub-optimal plant washes with a build-up of bacteria in the milking equipment and shed piping, in turn leading to a reduction in milk quality. Where waste water temperatures fall below 60° Celsius an alert can be triggered to the farmer, shed staff or service person and delivered via email, app, or text message etc. A lower than expected waste water temperature could mean the initial temperature of the water at the start of the plant wash was not high enough prompting the farmer to check the shed hot water system. Any problems can therefore be rectified immediately, and certainly prior to the next plant wash.
      There are occasions where the farmer may circulate the wash water a second time. In these instances, the temperature of the wash water as it exits the plant will be lower than the required 60° Celsius. This can trigger an alert, but is easily investigable and/or explainable.
      The system 101 can also measure the plant wash time, a key component of the effectiveness of a wash. This will simply be measured and recorded and the information made available to the farmer on an average basis.
   b. For the milk vat
      In order for milk vat cleaning chemicals to be effective they require an optimised combination of chemical concentration, temperature and time in the cleaning process. The system can measure the temperature of the waste water immediately after the milk vat wash is completed. This temperature should not be lower than 56° Celsius. Any temperatures lower than this, on a continuous basis, could lead to sub-optimal milk vat washes with a build-up of bacteria in the milk vat, in turn leading to a reduction in milk quality. Where waste water temperatures fall below 56° Celsius an alert can be triggered to the farmer, shed staff or service person and delivered via email, app, or text message etc. A lower than expected waste water temperature could mean the initial temperature of the water at the start of the milk vat wash was not high enough prompting the farmer to check the shed hot water system. Any problems can therefore be rectified immediately, and certainly prior to the next milk vat wash.
      The system 101 can also measure the milk vat wash time, a key component of the effectiveness of a wash. This will simply be measured and recorded and the information made available to the farmer on an average basis.
4. pH of wash water out of range
   The pH reading of the wash water, while in the wash tub, prior to being circulated around the plant or milk vat, is an indication of the level of acidity or alkalinity of the wash water. If mixed correctly (chemical and water) the pH of the solution will fall within the suppliers recommended range for both acidity and alkalinity. For any pH readings outside the set range an alert can be triggered informing the farmer, shed staff, service person of the discrepancy. The farmer can then adjust the quantity of chemical for both the acid and alkali wash for the very next wash. Where the acidity or alkalinity of the wash water is consistently incorrect when measured against the suppliers recommendation the chance of suboptimal washes taking place is increased. The pH sensor alert allows the farmer to rectify the wash water acidity or alkalinity immediately, and certainly before the next wash, thereby maintaining optimal wash quality and reducing the instance of supplying lower quality milk.
5. Wash contact time out of range
   For successful cleaning of the milk lines in the plant the contact time of the hot water circulating in the pipes is critical. The recommended time for hot water to circulate is 5-7 minutes. Anything less than 5 minutes could mean that cleaning was sub optimal because of the short contact time. The system will monitor and record the wash time per plant wash, and alerts will be generated for times that do not meet the minimum time requirement.
6. Milk temperature out of range
   Milk from the cows is required to be cooled prior to entering the milk vat. Milk within the vat must also be chilled, and preferably within 2 hours of milking. The longer that milk is left in a warm state the longer there is for bacteria to multiply in more favourable warmer conditions. The primary cooling system should bring the milk temperature to 18° Celsius when entering the milk vat. The shed refrigeration system should bring the milk temperature in the milk vat to 6° Celsius within 2 hours of the completion of milking and held at or below this temperature.
   Milk temperature sensors can be placed to measure these temperatures, and where temperatures fall outside this range an alert is triggered to the farmer, shed staff, service staff etc. informing them of the diversion. The farmer can then immediately investigate and attend to the potential problem causing the milk temperature discrepancies.
7. Teat spray quantity per cow out of range (calculation)
   Teat spray is formulated to be applied to each cow in certain ratios and quantities. These ratios and quantities can be set depending on the environmental conditions. They are typically set and applied for a period of time and changed when conditions warrant a change. These changes can be made on the user interface. From these settings, and the average number of cows milked each milking as input by the farmer/shed staff, the system can calculate the average volume of teat spray applied to each cow. If this average volume falls outside a min/max level for that setting the system can alert the farmer, shed staff, or supplier service person etc., indicating the discrepancy in application. Message delivery can be via email, over an app, or simple text message to a mobile phone etc. The farmer thus has an opportunity to immediately rectify teat spray spraying activities in the shed, and certainly prior to the next milking. Cows not sprayed correctly or adequately with teat spray at the end of each milking may be susceptible to an increased incidence of mastitis, and this can lead to reduced milk quality.
8. BMSCC (Bulk Milk Somatic Cell Count)
   Milk processors conduct this test as it checks milk for cells from the cow's body and blood. These cells normally occur in low numbers, but increases when cows have mastitis. When a cow has a mastitis infection it releases white blood cells to fight the infection, therefore a high level of somatic cells in the milk indicates the presence of a mastitis infection. Therefore, the SCC test is an indicator of herd mastitis infection levels. The system can receive SCC data from milk processors. The system settings for SCC can be set at levels more stringent than those imposed by the milk processors. If there is an increase in the SCC level from one reading to the next as supplied by the milk processor the system can alert the farmer, shed staff, service person to this prior to the level reaching that imposed by the milk processor. The farmer can then immediately investigate the herd and/or treat those cows identified, and together with investigating any mitigating factors on farm, adjust the teat spray concentration accordingly, for example, by increasing the overall quantity of mixed teat spray applied to each cow—in order to add a level of protection to the cow and reduce the incidence of mastitis.
9. Bactoscan/Coliform/Thermoduric
   The Bactoscan measures all types of bacteria (total bacteria) so a number of varying factors could contribute to a milk quality downgrade. A Bactoscan grade is commonly the result of poor plant hygiene, the result of cooling and/or refrigeration failures and a mastitis infection could also result in a Bactoscan grade.
   The most common form of a Coliform downgrade is a plant hygiene problem. A Coliform downgrade will normally be found in one particular place as Coliform bacteria are easily killed by hot water so you will normally find them in a place where hot water is not getting too. Milk needs to be cooled as rapid growth of Coliform bacteria will occur if the milk is not cooled to 6° Celsius within 2 hours of the completion of milking, and held at or below this temperature.
   Thermodurics are a group of bacteria that can survive pasteurisation, and this means they are particularly dangerous. Thermoduric downgrades from hygiene are normally the result of a protein build up, old milk soil build-up and/or perished rubberware. Common areas for build-up are the milk line and the bulk milk vat.
   For each of the bacteria types discussed above, the system can receive data from the milk processors. The system settings for these bacteria can be set at levels more stringent than those imposed by the milk processors. If there is an increase in the bacteria level from one reading to the next as supplied by the milk processor the system can alert the farmer, shed staff, service person to this prior to the level reaching that imposed by the milk processor. Based on the bacteria type reading the farmer can immediately investigate a particular part of the plant to identify the cause.
   Besides the cleaning of the affected components one of the solutions to mitigate a further deterioration in plant hygiene is to carry out a ‘double concentrated’ plant or milk vat wash. This can be done by selecting the appropriate wash programme on the user interface (called a ‘Bomb’ wash on the user interface 7, 107).

Further, the system 101 can monitor the number of various programmes run and/or usage data for plant components, and some components—for example rubberware and filter socks—can be monitored using sensors. Consumables such as filter socks, liners, rubber seals etc. have limited life spans, and the system may be configured to alert the farmer of the need to replace them based on manufacturer's usage and replacement programmes.

Data from the database 123 may also be accessed to monitor and charge for the use of chemicals from the storage reservoirs 103a-n. Rather than the farmer purchasing bulk amounts of chemical by the drum, the supplier may maintain ownership of the drums of chemicals installed in the system and generate invoices periodically based on actual usage of chemicals. For example, a monthly invoice may be generated to charge for the quantity of chemical solution(s) used the preceding month.

The system controller 105 may be accessible remotely, for example, by a technician or computer programmer via the network 121, with each system controller having a unique identifier or address. This advantageously enables any necessary changes or software updates to the system to be made remotely, or some technical faults to be corrected remotely.

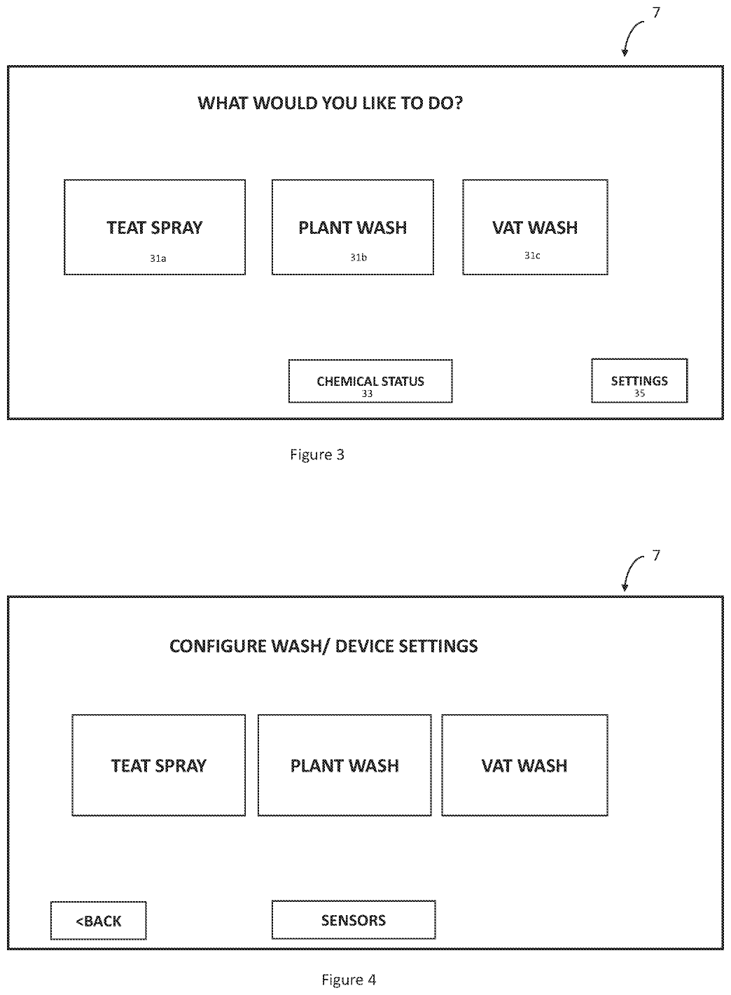

Referring to FIGS. 3 to 8, the graphical user interface 7 may comprise a touch screen interface that provides a user with options for dispensing and mixing chemicals and which can receive dispensing and other instructions from a user. Alternatively, a non-touchscreen interface may be provided. The user interface 7 communicates with the system controller 105 to provide instructions for operation of the dosing (chemical management) system 11. The user interface 7 is installed in the dairy shed where the dispensing system is installed, preferably near the system controller 105, and is preferably water resistant.

In addition to the graphical user interface 7, an emergency on/off button may be provided, for example on the controller housing. The emergency button can be pressed to immediately shut down the system and to abort any programme running at the time.

FIGS. 3 to 8 provide examples of screens the user interface 7 may present to an operator to obtain input instructions from a user. It will be understood that these screens are exemplary and that many other layouts, configurations and options are possible. The user interface 7 enables a user to select the chemical solution(s) to be mixed and to specify the strength, volume, or application of the mixed solution. Generally, the interface 7 will have a main menu as shown in FIG. 3, from which a user can choose to check status of chemical concentrate volume per storage conduit (button 33), change the settings for pre-programed mixing programmes (button 35), or provide instructions for mixing and dispensing chemicals (buttons 31a, 31b, 31b).

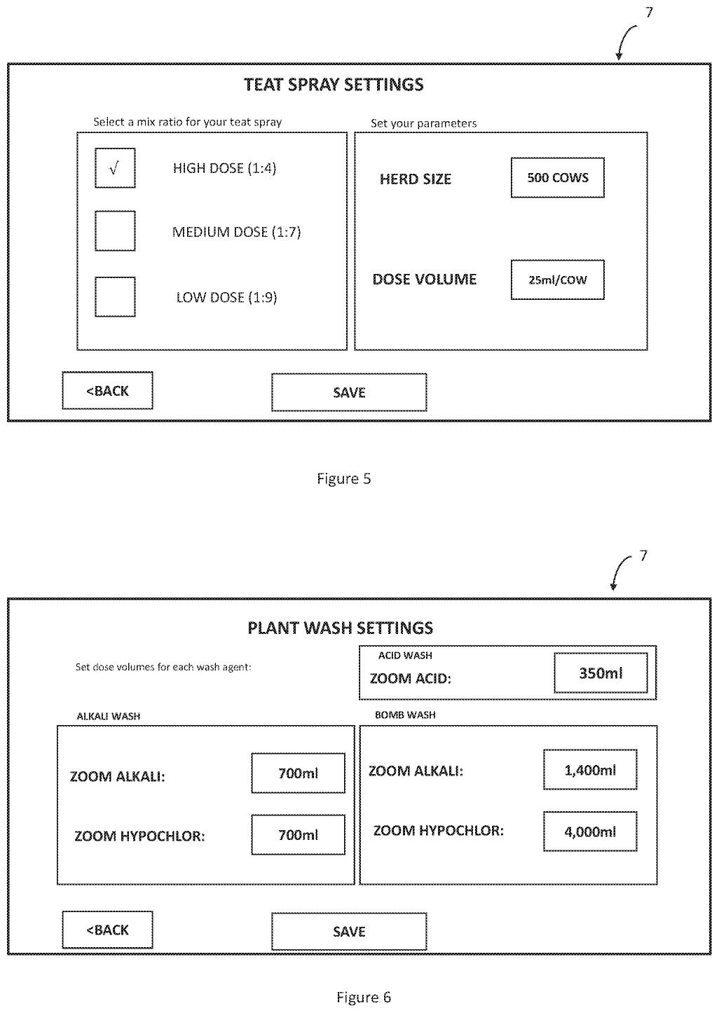

FIG. 4 illustrates a screen from which a user can change the settings for pre-programed mixing programmes, in this example the pre-programed mixing programmes are a teat-spray mix, a plant wash mix, and a vat wash mix. The settings may either allow a user to enter specific quantities for the chemical concentrates or specify conditions or parameters that are associated with pre-determined amounts. For example, FIG. 5 shows an example screen where a user can specify parameters such as environmental conditions and the herd size for the system to calculate a recommended dose, or they may enter a specific required dose volume per cow. This system does not pre-populate the dose volume—instead the user selects either high dose, medium dose, low dose, but can still keep the dose volume at 25 ml/cow. The user also has the ability to change the dose volume per cow.

FIG. 6 illustrates a screen from which a user can change the settings for various pre-programed wash programs. In this example, the wash programs include an alkali wash, and acid wash, and a ‘bomb’ wash. A ‘bomb’ wash is a highly concentrated wash, for example, with twice the amount of acid, or twice the amount of alkali that may be required in the event of an increase in bacterial build up or an increase in the build-up of fat and protein. For these washes, the user can input the required volumes of various wash agents for each of these washes. Settings entered by a user are retained for each program until they are next changed.

The user interface 7 may also enable the calibration of sensors.

The user interface 7 may enable other checks or operations related to the operations in the dairy shed. For example, the user interface may provide prompts or include safety checks, for example to require confirmation that staff are wearing the required personal protective equipment prior to mixing and handling chemicals managed by the system or to remind staff of health and safety procedures that are to be followed when handling chemicals.

The user interface 7 may facilitate ordering of replacement product or other consumables for the dairy shed. Ordering may be prompted based on the level of chemical remaining in the storage reservoirs 103a to 103n. When the sensed quantity of chemical solution remaining in a respective storage reservoir is below a threshold amount, the user may be prompted to order for replenishment of said chemical solution. The user interface may be configured to receive the instructions for re-order from the operator, and to transmit the order via the system controller 105 and network 121 to a supplier of the chemical solution.

Alternatively, the controller 105 may be configured to automatically place an order for replenishment of a chemical solution when the sensed quantity of chemical solution remaining in a respective storage reservoir is below a threshold amount, for example when a supply arrangement is in place with a third party. The controller 105 alerts the supplier of the type of chemical required, for example by generating an email or SMS method, such that a new full drum can be delivered to replace the empty drum. Ensuring drums are replaced promptly reduces the chance of a farmer running out of a chemical and therefore ensures daily wash programmes are always able to be made with the correct chemicals.

When a new drum of a chemical solution (from the drums 103a to 103n) is delivered, the capacitive level switch (selected from 118a-n) is removed from the empty drum and securely fitted onto the replacement drum. Information about the new drum such as the batch number and drum size can be input into the database 123 via the user interface 7.

In addition, the present invention will allow for chemical ‘batch’ numbers to be recorded. This allows for quick reference for auditors/processors if there is a regional contamination event that could have a significant impact on processors milk quality. Recorded batch reference to chemicals allows for greater traceability back to the chemical manufacturer and ensures a more efficient trail of information in an event like this.

An automated system that is able to record cleaning practices and/or use of animal veterinary products would be beneficial to auditors and to milk processors who are now commonly audited by their international export customers to ensure that milk quality ‘on farm’ is sufficient to meet consumer expectations.

### Teat Spray Operation Example(s)

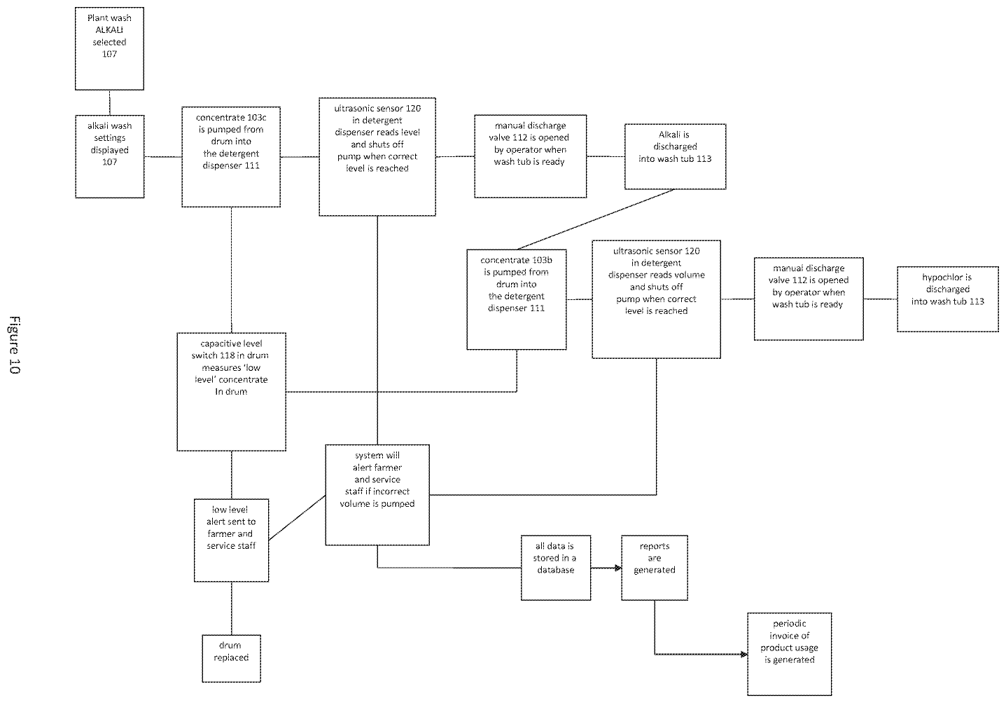

FIG. 9 illustrates an exemplary method for mixing a teat spray using the system 101 of FIG. 2. To initiate the mixing of teat spray 107, a user selects this option on the user interface 7. The controller then opens a valve 14 which allows water from a pressurised water supply 104 to pass through a pressure regulator 15 and through a flowmeter 12. The water enters an inline mixing pump 109 (such as a venturi). The action of the water in the mixing pump 109 draws teat spray concentrate from the storage drum 103d and mixes the teat spray at the concentration required and set by the pump nozzle selected. The mixed teat spray is delivered directly to a mixed teat spray storage drum 110. The mixed teat spray volume in the storage drum 110 will increase until it reaches a full level at which point a level switch 121 will close the solenoid valve 14 and the pump will stop mixing.

The shed teat spray system then can draw the mixed solution from the mixing drum 110.

The system calculates the ratio of teat spray mixed by the inline pump. An alert can be triggered if the ratio of the calculated mixed teat spray differs from the ratio required. The system calculates the volume of mixed teat spray delivered to the shed. The system can calculate the average volume of mixed teat spray delivered per cow. An alert can be triggered if the average volume per cow is higher or lower than required. All data is logged in the database 123 along with the date and time. From this data, reports may be generated for auditing or other purposes, and invoices may be periodically generated to invoice for the quantity of teat spray concentrate used.

When the level of the teat spray concentrate in drum 103d reaches the level switch indicating a low level of product in the drum the system will generate an alert of the product status and replacement of the drum can be arranged.

### Alkali Wash Operation Example(s)

For an alkali wash two different chemicals are measured separately. The user selects plant alkali wash on the user interface 107. The alkali wash settings are displayed on the screen. Chemical concentrate is pumped from the storage drum 103c into the detergent dispenser 111. The sensor 120 in the detergent dispenser reads the level of the chemical and shuts off the pump when the correct level is reached. The manual discharge valve 112 is opened by the operator when he/she is ready to discharge the chemical into the wash tub 113. Once discharged into the wash tub the operator closes the manual discharge valve 112. The system then pumps concentrate from storage drum 103b into the detergent dispenser 111. The sensor 120 in the detergent dispenser reads the level of the chemical and shuts off the pump when the correct level is reached. The manual discharge valve 112 is opened by the operator when he/she is ready to discharge the chemical into the wash tub 113. Once discharged into the wash tub the operator closes the manual discharge valve 112.

If, for whatever reason, the level in the detergent dispenser is incorrect the system can alert the farmer and service staff.

A level switch 118 on the storage drum 103b measures a ‘low level’ of concentrate in the drum. Once reached an alert can be sent to the farmer or service staff and the drum replaced. All data is recorded and stored in the database 123 along with date and time, and farm number.

The wash tub 113 is equipped with one or more sensors to measure properties, such as the pH of the solution in the wash tub 113. Incorrect pH levels of the alkali wash solution can reduce(s) the ability of the mixture to clean protein and fat residue in/from the plant, and can therefore potentially be related to reduced milk quality issues.

Properties of the wash water at one or more stages of the wash may also be measured, particularly the temperature of waste wash water as it leaves the plant (step 313). If the temperature is too low, this can indicate the wash as ineffective.

Measurements from the sensors are logged in the database 123 along with the date and time and information about the wash type and volume, and the status of the storage reservoirs. From this data, reports may be generated for auditing or other purposes, and invoices may be periodically generated to invoice for the chemicals used.

If as a result of mixing the plant wash, the pH of the solution falls below a predetermined threshold level, the controller may issue an alert to the farmer or shed staff who may arrange to add more concentrate to the solution to adjust the pH.

### Acid Wash Operation Example(s)

FIG. 12 illustrates an exemplary method for mixing a plant acid wash 107 for a milking facility using the system 101 of FIG. 2.

To initiate an acid wash, a user selects the acid wash option on the user interface 107. The acid wash settings are displayed on the screen. Chemical concentrate is pumped from drum 103a into the detergent dispenser 111. Ultrasonic sensor 120 in the detergent dispenser reads level of chemical and shuts off the pump when the correct level is reached. The manual discharge valve 112 is opened by the operator when he/she is ready to discharge the product into the wash tub. A level switch on the storage drum is activated when the level of chemical reaches it. A low level alert can be sent to the farmer and service staff when this level is reached. The drum can then be replaced. The system can alert the farmer and service staff if the incorrect volume of concentrate is pumped into the detergent dispenser.

Some systems will run a pump for a pre-determined amount of time to get the required volume, but this may not always be 100% accurate due to outside factors such as weather temperature affecting the viscosity of the liquid i.e., these pumps may not always run at exactly the same speed.

The wash tub 113 is equipped with one or more sensors to measure properties, such as the pH of the solution in the wash tub 113. Incorrect pH levels of the acid wash mixture can reduce the ability of the mixture in cleaning mineral deposits in the plant. If the pH of the acid wash mixture is outside pre-set acceptable parameters, the system may trigger an alert to notify the operator.

Properties of the wash water at one or more stages of the wash may also be measured, particularly the temperature of waste wash water as it leaves the plant (step 416). If the temperature is too low, this can reduce the effectiveness of the wash.

Measurements from the sensors are logged in the database 123 along with the date and time and information about the wash type and volume, and the status of the storage reservoirs. From this data, reports may be generated for auditing or other purposes, and invoices may be periodically generated to invoice for the acid concentrate used.

A further advantage/embodiment of the present invention relates to environmental impacts. Namely, there is growing pressure on farmers to reduce their environmental impact. Chemical products used for dairy plant hygiene, teat sprays and minerals etc are commonly packaged in 200 litre drums. There is a significant carbon footprint associated with the production and delivery of these drums to a farm. Moreover, once these drums are empty, they become waste on the farm which must be stored somewhere and/or disposed of. The present invention allows the monitoring of how much chemical is being used by the farmer, and therefore the farmer may be billed/invoiced the actual quantity of chemical used rather than by the price of the drum. Thus, the system allows for the use of larger drums, e.g. 1000 litre rather than 200 litre. Moreover, the 1000 litre containers are able to be recycled once the chemical has been used. As such the system provides the chemical on a ‘consignment’ basis and the farmer only pays for what has been used. The larger drum size then both substantially reduces the number of plastic drums (1×1000 litre v 5×200 litre), the number of vehicle movements to and from farm, and also eliminates the plastic waste from the farm. This approach then substantially reduced the environmental impacts associated with farming.

A further advantage/embodiment of the present invention relates to the safety. Namely, many of the chemicals used in the dairy plant are harmful (particularly acid and alkali), and these chemicals can therefore cause serious injury if they come into contact with the skin/eyes of a worker or if they are mixed inappropriately or incorrectly (e.g., acid and alkali incorrectly mixed together may create mustard gas). Often the mixing and delivery of these chemicals is done manually and without appropriate safety equipment. The present invention substantially reduces any risk for these types of events occurring. This is an advantage for staff on farm but also for the owners/directors of the company that have legal responsibility for the health and well-being of staff and having appropriate systems in place to minimise risk. This will also limit potential Director's liability.

### Variations

Preferred embodiments of the invention have been described by way of example only and modifications may be made thereto without departing from the general spirit and/or scope of the invention.

1-49. (canceled)

50. A monitoring system associated with the operation of a dairy plant, said system being adapted or able to monitor a dispensing system for dispensing chemicals, said dispensing system including:
a. at least two storage reservoirs, each for containing a respective chemical solution,
b. a water source,
c. a mixing system,
d. a dosing system coupled to the storage reservoirs and to the water source, for selectively dispensing one or more of the chemical solutions and water into the mixing system to form a mixed solution,
e. a user interface for receiving dispensing instructions from a user,
f. a controller for operating the dosing system in accordance with the dispensing instructions,
g. a sensor in communication with the controller, configured to measure a property of at least one dispensed chemical solution and/or of the mixed solution, the controller being configured to log information from the sensor in a database,
wherein any or all data obtained or generated, and/or any workings on the data, is able to be transmitted to a remote location, the arrangement and construction being such that the data, and/or any workings on the data, is accessible by one or more of:
h. a farmer,
i. a service staff,
j. an auditor, whereby the system allows for remote monitoring of the dairy plant by the auditor.

51. The monitoring system of claim 50, wherein the data, and/or any workings on the data, is also accessible by a dairy processor.

52. The monitoring system of claim 50, wherein the data, and/or any workings on the data, is transmitted to the remote location in real time.

53. The monitoring system of claim 50, wherein the system is configured to automatically place an order for replenishment of a chemical solution when the sensed quantity of the chemical solution is below a threshold amount.

54. The monitoring system of claim 50, wherein the data, and/or any workings on the data, is able to be used and/or manipulated in order to generate a milk quality report(s).

55. The monitoring system of claim 54, wherein the milk quality report(s) is sent to one or more of: the auditor, the farmer, the service staff and the dairy processor.

56. The monitoring system of claim 55, wherein the milk quality report(s) is adapted to be sent automatically in real time or near-real time.

57. The monitoring system of claim 50, wherein the data obtained or generated includes data in relation to one or more of the following cleaning elements associated with operation of the dairy plant: chemical concentration, temperature, turbulence and time in/of the cleaning process—and ensuring said one or more elements are within an appropriate or optimal range.

58. The monitoring system of claim 50, wherein the data obtained or generated includes data in relation to the mixing and/or administering of animal health products and/or mineral supplements, and ensuring all concentrations and/or amounts are within an appropriate or optimal range.

59. The monitoring system of claim 50, wherein the monitoring system is further adapted, or able, to generate an alert when certain readings/measurements and/or conditions are met (or not met).

60. The monitoring system of claim 59, wherein the alert(s) is capable of being automatically generated or and/or sent in real time.

61. The monitoring system of claim 50, wherein the chemical solutions include one or more of: a teat wash or mastitis treatment, a detergent, an acid plant wash, an alkali plant wash, one or more animal health products, and/or a mineral supplement.

62. The monitoring system of claim 61, wherein a first one of the storage reservoirs includes a teat wash or mastitis treatment, and a second one of the reservoirs includes a detergent and/or an acid plant wash, and/or an alkali plant wash.

63. The monitoring system of claim 62, wherein the sensor is configured to measure one or more of the volume, concentration, temperature, and/or pH of a solution in the mixing system.

64. The monitoring system of claim 63, wherein the user interface enables a user to select the chemical solution(s) to be mixed and to specify the strength, volume, or application of the mixed solution.

65. The monitoring system of claim 64, wherein the user interface enables a user to specify the application for the mixed solution, and wherein for a given specified application, the controller retrieves one or more of the required volume or strength of the mixed solution.

66. The monitoring system of claim 65, wherein the user interface can also be used for re-ordering chemicals, and/or confirming the use of safety PPE, and/or for alerting a user to measurements outside set parameters.

67. The monitoring system of claim 66, wherein the mixing system includes an outlet coupled to a spray system for spraying cow udders for mastitis treatment.

68. The monitoring system of claim 67, which further includes a temperature sensor placed in a suitable position at a waste water outlet of the dairy plant wash or spray system, to measure the temperature of the wastewater.

69. The monitoring system of claim 68, further including one or more chemical level sensors arranged to sense the quantity of chemical solution remaining in a respective storage reservoir.

70. The monitoring system of claim 69, wherein the controller is configured to receive sensed data from the chemical level sensors and, when the sensed quantity of chemical solution remaining in a respective storage reservoir is below a threshold amount, to transmit this data to a remote location and/or produce an alert on the user interface.

71. The monitoring system of claim 70, wherein the controller is configured to record one or more of:
(a) a measured property of at least one dispensed chemical solution,
(b) a measured property of the mixed solution along with the time and date,
(c) information about the type of solution mixed,
(d) instructions input by user via the user interface,
(e) information about use of the mixed solution, in the database, alongside date and time data, and batch number.

72. The monitoring system of claim 71, wherein the mixing system is configured to supply fluid from the mixing system to a wash or spray system for washing a dairy plant, and/or for spraying cows udders for mastitis treatment, and the system controller is configured to log the volume and strength of fluid dispensed to the dairy plant wash or spray system, along with the time and date the fluid was dispensed.

73. The monitoring system of claim 72, wherein the controller is further configured to receive and log a temperature measurement from a temperature sensor at a waste water outlet of the dairy plant wash or spray system.

74. An automated method for mixing chemicals for washing a dairy plant using the monitoring system of claim 50, said method including the steps of:
a. obtaining desired mixture parameters from a user via the user interface,
b. dispensing water from the water source and an acid or alkali concentrate into the mixing system to create a mixed solution in accordance with the parameters,
c. measuring the pH level of the solution in the mixing system,
d. logging the pH level in the database,
e. measuring a temperature of wastewater at a plant wash outlet, and
f. logging the wastewater temperature in the database.

75. The method of claim 74, further including the step of recording in the database, alongside date and time data, one or more of:
(a) a measured volume of the dispensed acid or alkali concentrate,
(b) a measured volume or concentration of the mixed solution,
(c) information about the type of solution mixed,
(d) instructions input by the user via the user interface,
(e) information about use of the mixed solution,
(f) the level of acid or alkali concentrate remaining in the respective storage reservoir,
(g) information about the pH of the mixed acid or alkali solution prior to the wash being started,
(h) information about the temperature of the mixed acid or alkali solution after the wash has been completed,
(i) information about the time taken for the plant wash to be carried out,
(j) information about the time taken for the vat wash to be carried out.

76. An automated method for dispensing an animal teat treatment using the monitoring system of claim 50, said method including the steps of:
obtaining desired mixture parameters from a user via the user interface,
dispensing water from the water source and a teat treatment concentrate from one of the storage reservoirs, into the mixing system to create a mixed solution in accordance with the parameters,
applying the mixed solution, directly or indirectly, to animal teats,
recording in the database, alongside date and time data, one or more of:
(a) a measured volume of the dispensed teat treatment concentrate,
(b) a measured volume or concentration of the mixed solution,
(c) the volume of the mixed solution dispensed,
(d) information about the type of solution mixed,
(e) instructions input by the user via the user interface,
(f) information about use of the mixed solution,
(g) the level of teat treatment concentrate remaining in the respective storage reservoir.
